(19) United States
(12) Patent Application Publication
(10) Pub. No.: US 2025/0132782 A1
(43) Pub. Date: Apr. 24, 2025

(54) METHOD AND SYSTEM FOR TRANSMITTING DC POWER SUPPLY AND SIGNALS BY USING A PAIR OF WIRES

(71) Applicants: Yunfan Huang, Yangzhou (CN); Shangbin Xiao, Shenzhen (CN)

(72) Inventors: Yunfan Huang, Yangzhou (CN); Shangbin Xiao, Shenzhen (CN)

(21) Appl. No.: 19/000,792

(22) Filed: Dec. 24, 2024

(51) Int. Cl. H04B 3/54; H02J 1/06

(52) U.S. Cl. CPC H04B 3/548; H02J 1/06; H04B 3/542

(57) ABSTRACT

A method and a system for transmitting DC power supply and signals by using a pair of wires, wherein the DC power supply adopts a pair of wires to supply power to electric equipment, and a data sending end communicates to a data receiving end unidirectionally; the data sending end is positioned at the DC power supply, the data receiving end is positioned at an electric equipment end; at power supply end, a pair of wires is divided into wire A and wire B, when digital signal sent by data sending end is at a high level, wire A is connected with positive pole of power supply, wire B is connected with ground of power supply, when digital signal sent by data sending end is at a low level, wire A is connected with ground of power supply, and wire B is connected with positive pole of power supply.

### 1. TECHNICAL FIELD

The present application relates to the field of power and information transmission, and more particularly to a method and system for transmitting DC power supply and signals by using a pair of wires.

### 2. BACKGROUND ART

Power line carrier communication is an electric power system communication that uses electric transmission lines as transmission medium for carrier signals. As the electric transmission line has a very strong support structure, and set up more than 3 wires (generally three-phase good wires and one or two overhead ground wires), so when the power transmission line transports the power current, it's also used for transmission of carrier signals at the same time, economic and reliable. The comprehensive utilization of the communication method has long become a special communication means preferentially adopted by all power departments in the world.

At present, power line carrier communication is widely used in household meter reading, which saves manpower and material resources for power supply enterprises in household meter reading. These power line carriers are alternating current (AC), generally 50 HZ or 60 HZ alternating current; if direct current is used (DC), the existing power line carrier technology cannot be used and realized, which is because the DC transmission is generally not too far away, such as centralized power supply to all communication equipment in a communication base station, in such a way, first of all, the AC power supply that is, the utility power enters the base station, and then rectification filtering is carried out in the base station to form a stable DC power supply, for example, some base stations will convert the the utility power into 28 VDC (sometimes also converted into 36 VD, 24 VD) to transmit differential equipment, and they are in the station to transmit DC power supply, so there will not be too far away, generally in a distance at a kilometer level; at this time, a central control unit of the base station is typically located near a regulated power supply and communication between the central control unit of the base station and the respective differential equipment is accomplished via dedicated communication cables. In addition, there are some usage scenarios, such as some existing smart homes, many smart devices need to use a DC power supply; therefore, sometimes, when entering a home, the utility power is converted into a DC power supply (ACDC conversion is generally completed in a household power distribution cabinet), and then, a pair of wires is used to transmit the DC power supply to each smart home device in the home; at this time, if a centralized control device is disposed in the power distribution cabinet, and it is necessary to control each smart home device, communication between the power distribution cabinet and each smart home device needs to be realized; at present, because wiring has already been finalized, only pairs of power wires between each pair of smart home devices is used, and at many times, one pair of wires is used to realize power supply, digital communication needs to be realized by using the pair of wires; attempts have been made in the industry to use a pair of wires to simultaneously carry both DC power and digital signals, one of the wires is a common Ground (GND), while an other wire is a power supply (VCC), to load digital signals on the power supply; as shown in FIG. 1, it is a signal diagram of a 36 VDC transmission wire loaded with non-return-to-zero digital square waves, as can be seen from the figure, it is theoretically possible, but in practice, due to the resistor of the wire, the voltage on the power line is considerable after a certain distance is exceeded, another pair of wires also has distributed capacitors, and due to the electromagnetic interference of the external environment, the communication distance is not too far; if the voltage of the transmitted DC power supply is lower, such as 24 VDC, 18 VDC, 12 VDC and the like, the anti-interference capability is weaker, the distance for transmitting the digital signals is closer, which cannot meet the digital communication requirements of the smart home.

### 3. SUMMARY OF THE INVENTION

The application aims to provide a method and a system for transmitting DC power supply and signals by using a pair of wires, which have strong anti-interference capability and long transmission distance.

The technical scheme of the application is as follows: a method for transmitting DC power supply and signals by using a pair of wires, in the method, the DC power supply adopts a pair of wires to supply power to electric equipment, and a data sending end communicates to a data receiving end unidirectionally at the same time; the data sending end is positioned at the DC power supply, and the data receiving end is positioned at an electric equipment end;

At a power supply end, a pair of wires is divided into a wire A and a wire B, when the digital signal sent by the data sending end is at a high level, the wire A is connected with a positive pole of the power supply, the wire B is connected with a ground of the power supply, when the digital signal sent by the data sending end is at a low level, the wire A is connected with the ground of the power supply, and the wire B is connected with the positive pole of the power supply;

at the electric equipment end, the data receiving end samples electric signals, regardless of whether it is wire A or wire B, and the wire with high level is connected with a positive pole of the electric equipment power supply, and an other wire is connected with a ground of the electric equipment power supply.

Further, in the method for transmitting DC power supply and signals by using a pair of wires as described above: when the data receiving end samples electric signals, acquiring signals on the wire A or wire B, and comparing the acquired electric signals with ground of the electric equipment power supply; if the voltage of the acquired electric signal is higher than the ground of the power supply, judging that the received digital signal is “1”, otherwise, judging that the received digital signal is “0”; and then, carrying out reverse phase calculation on the received numeric string according to communication protocol to restore the original transmission signal.

Further, in the method for transmitting DC power supply and signals by using a pair of wires as described above: when the data receiving end samples electric signals, acquiring signals on the wire A and wire B simultaneously, and comparing the acquired signals on the wire A with the acquired signals on the wire B, if the voltage of the acquired signal on the wire A is higher than that of the acquired signal on the wire B, the received digital signal is judged to be “1”, and if not, the received digital signal is “0”; and then, carrying out reverse phase calculation on the received numeric string according to communication protocol to restore the original transmission signal.

Further, in the method for transmitting DC power supply and signals by using a pair of wires as described above: when the data receiving end samples electric signals, a wire C is adopted to connect the wire A and wire B, a current-limiting resistor is connected in series with the wire C, and the current direction of current on the wire is acquired; if the current direction flows from the wire A to the wire B, the received digital signal is judged to be “1”, otherwise, the digital signal is “0”; and then, carrying out reverse phase calculation on the received numeric string according to communication protocol to restore the original transmission signal.

Further, in the method for transmitting DC power supply and signals by using a pair of wires as described above: at the data sending end, the sent digital fundamental wave signal is a unipolar non-return-to-zero code.

The application also provides a system for transmitting DC power supply and signals by using a pair of wires, wherein the DC power supply utilizes a pair of wires including wire A and wire B to supply power to an electric terminal equipment, and wherein the DC power supply end also has a data sending terminal utilizing a pair of wires to send digital fundamental wave signals to a data receiving terminal set at the electric terminal equipment;

At the DC power supply end further comprises a modulation device for modulating the digital fundamental wave signal power supply output signal sent by the data sending terminal; said modulation device has wire A connected to the positive pole of the power supply and wire B connected to the ground of the power supply when the digital fundamental wave signal sent by the data sending terminal is at a high level, and wire A connected to the ground of the power supply and wire B connected to the positive pole of the power supply when the digital signal sent by the data sending terminal is at a low level;

At the electric equipment end further comprises an electrical signal sampling circuit and a power restoration device for restoring signals on wire A and wire B into current output signals; said electrical signal sampling circuit is connected to the data receiving terminal, and said power restoration device realizes that, regardless of whether it is wire A or wire B, a wire with a high level is connected to the positive pole of the electric equipment power supply, and the other wire is connected to the ground of the electric equipment power supply.

Further, in the system for transmitting DC power supply and signals by using a pair of wires as described above: said modulation device includes a double-pole-double-throw switch K10 controlled by a relay, a triode Q10, and a current-limiting resistor R10; a fixed end of a 1 #pole of said double-pole-double-throw switch K10 is connected to the wire A, a fixed end of a 2 #pole is connected to the wire B; when the relay is attracted, a free end of the 1 #pole is thrown to a positive pole of the DC power supply, and the 2 #pole is thrown to the ground of the DC power supply. When the relay is not attracted, the free end of the 1 #pole is thrown to the ground (GND) of the DC power supply, and the free end of the 2 #pole is thrown to the positive pole of the DC power supply; the positive pole of the power supply is connected to a collector of the triode Q10 through the current-limiting resistor R10, and an emitter of the triode Q10 is connected to the ground of the DC power supply through a relay coil, and a base is connected to the data sending terminal.

Further, in the system for transmitting DC power supply and signals by using a pair of wires as described above: said modulation device comprises a MOS switch tube Q1, a MOS switch tube Q2, a MOS switch tube Q3, and a MOS switch tube Q4;

The positive pole of the DC power supply is connected to drain electrodes of the MOS switch tube Q1 and the MOS switch tube Q2, respectively, and source electrodes of the MOS switch tube Q1 and the MOS switch tube Q2 are connected to the wire A and the wire B, respectively;

The ground of the DC power supply is connected to drain electrodes of MOS switch tube Q3 and MOS switch tube Q4, and source electrodes of MOS switch tube Q3 and MOS switch tube Q4 is connected to wire A and wire B, respectively;

A digital signal D+ output from the data sending terminal is connected to grid electrodes of the MOS switch tube Q1 and the MOS switch tube Q3, respectively; and an inverse phase signal D− of the digital signal D+ is connected to grid electrodes of the MOS switch tube Q2 and the MOS switch tube Q4, respectively.

Further, in the system for transmitting DC power supply and signals by using a pair of wires as described above: said power restoration device comprises a double-pole double-throw switch K20 controlled by a relay, and a current-limiting resistor R20; a fixed end of a 1 #pole of said double-pole double-throw switch K20 is connected to the wire A, and a fixed end of the 2 #pole is connected to the wire B, and when the relay is attracted, a free end of the 2 #pole is thrown to the positive pole of the electric equipment power supply, and the 2 #pole is thrown to the ground of the electric equipment power supply. When the relay is not attracted, the free end of the 2 #pole is thrown toward the ground of the electric equipment power supply, and the free end of the 1 #pole is thrown toward the positive pole of the electric equipment power supply; the wire B is connected in series with the relay coil to ground through the current-limiting resistor R20.

Further, in the system for transmitting DC power supply and signals by using a pair of wires as described above: said electrical signal sampling circuit includes a sampling resistor R1 and a sampling resistor R2; said sampling resistor R1 and sampling resistor R2 are connected in series between wire B or wire A and ground, and a sampling signal is led out from a common end connected to the sampling resistor R1 and sampling resistor R2 to connect to the data receiving terminal.

The system for transmitting DC power supply and signals by using a pair of wires of the application is highly resistant to interference and has a long transmission distance.

The application is further described in detail hereinafter with reference to the drawings.

### 4. BRIEF DESCRIPTION OF ACCOMPANY DRAWINGS

FIG. 1 shows a signal waveform when a method for transmitting DC power supply and signals by using a pair of wires of prior art is used;

FIG. 2 shows a signal waveform when a method for transmitting DC power supply and signals by using a pair of wires of the application is used;

FIG. 3 shows a schematic diagram of the power supply end of embodiment 1 of the application;

FIG. 4 shows a schematic diagram of the electric equipment end of embodiment 1 of the application;

FIG. 5 shows a schematic diagram of the power supply end of embodiment 2 of the application;

FIG. 6 shows a schematic diagram of the electric equipment end of embodiment 2 of the application.

### 5. SPECIFIC EMBODIMENT OF THE INVENTION

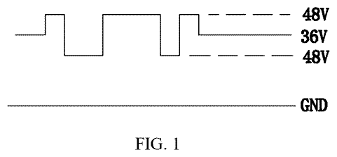

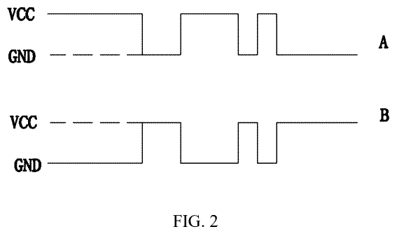

Embodiment 1: in this embodiment, in a smart home, after the household electric supply is converted into direct current in the household power distribution cabinet, the household electric supply is supplied to each intelligent household appliance in the household, and a pair of wires are used to transmit some control signals to the intelligent household appliance at the same time, so as to perform communication in a digital communication manner, that is, a pair of wires is used to transmit power supply and data communication signals at the same time; as shown in FIG. 2, in this embodiment, a waveform after the direct current signal and digital square wave information are modulated, and a digital signal “10011101” of the waveform is compared with the direct current signal and digital signal transmitted on one wire shown in FIG. 1, the amplitude of the square wave in this embodiment is the same as that of the direct current, but in the prior art, the amplitude of the square wave is only one third of the direct current signal at most; in addition, because the two wires A and B are connected with the ground in a crossing manner, the electric quantity in the capacitor between the two wires will be injected into the ground, so the influence on signal transmission is reduced to the minimum, therefore, the waveform has stronger anti-interference capability; meanwhile, because the amplitude is larger, the communication distance can be further, and since the amplitude of the method is consistent with the amplitude of a direct current signal, the waveform can also be used in a direct current transmission wire with lower voltage; and furthermore, because there is a voltage with an output voltage VCC of the DC power supply and a ground GND of the DC power supply is arranged at any time in the wire A and wire B, VCC and GND of the power supply can be restored at the electric equipment end, without affecting electricity consumption of the electric equipment.

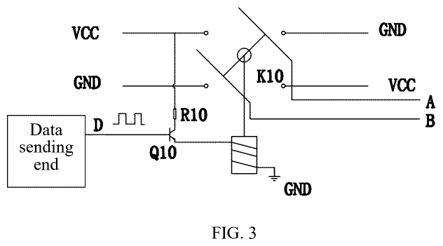

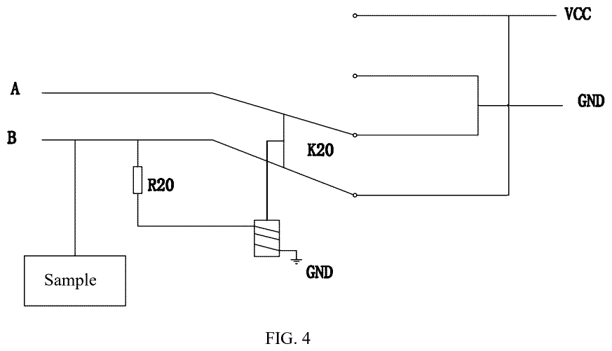

The circuit principle of the embodiment is shown in FIG. 3, and FIG. 4, a system for transmitting DC power supply and signals by using a pair of wires, the DC power supply adopts a pair of wires, namely wire A and wire B, to supply power to electric equipment terminal, the DC power supply end is also provided with a data sending terminal which transmits a digital fundamental wave signal to a data receiving terminal arranged at the electric equipment terminal by using the pair of wires; the DC power supply end also comprises a modulation device for modulating the digital fundamental wave signal power supply output signal sent by the data sending terminal; said modulation device has wire A connected to the positive pole of the power supply and wire B connected to the ground of the power supply when the digital fundamental wave signal sent by the data sending terminal is at a high level, and wire A connected to the ground of the power supply and wire B connected to the positive pole of the power supply when the digital signal sent by the data sending terminal is at a low level; at the electric equipment end further comprises an electrical signal sampling circuit and a power restoration device for restoring signals on wire A and wire B into current output signals; said electrical signal sampling circuit is connected to the data receiving terminal, and said power restoration device realizes that, regardless of whether it is wire A or wire B, a wire with a high level is connected to the positive pole of the electric equipment power supply, and the other wire is connected to the ground of the electric equipment power supply.

The modulation device of the embodiment is shown in FIG. 3, said modulation device includes a double-pole-double-throw switch K10 controlled by a relay, a triode Q10, and a current-limiting resistor R10; a fixed end of a 1 #pole of said double-pole-double-throw switch K10 is connected to the wire A, a fixed end of a 2 #pole is connected to the wire B; when the relay is attracted, a free end of the 1 #pole is thrown to a positive pole VCC of the DC power supply, and the 2 #pole is thrown to the ground GND of the DC power supply. When the relay is not attracted, the free end of the 1 #pole is thrown to the ground GND of the DC power supply, and the free end of the 2 #pole is thrown to the positive pole VCC of the DC power supply; in this embodiment, whether the relay is closed or not is controlled by a digital signal sent by the data sending terminal, when the transmitted digital signal is “1”, a high level is applied to the relay coil, the relay coil conducts current, attraction is performed, when the output electric signal is “0”, a voltage applied to the relay coil is a low level, at this time, no current exists in the relay coil, and the relay is not attracted. In this embodiment, a relay drive circuit is also disclosed, the control signal being a digital signal to be transmitted, as shown in FIG. 3, the relay drive circuit includes a triode Q10 and a current-limiting resistor R10, wherein the positive pole VCC of the power supply is connected to a collector of the triode Q10 through the current-limiting resistor R10, and an emitter of the triode Q10 is connected to the ground of the DC power supply through a relay coil, and a base is connected to the data sending terminal.

As shown in FIG. 4, in the embodiment, said power restoration device comprises a double-pole double-throw switch K20 controlled by a relay, and a current-limiting resistor R20; a fixed end of a 1 #pole of said double-pole double-throw switch K20 is connected to the wire A, and a fixed end of the 2 #pole is connected to the wire B, and when the relay is attracted, a free end of the 2 #pole is thrown to the positive pole VCC of the electric equipment power supply, and the 2 #pole is thrown to the ground GND of the electric equipment power supply. When the relay is not attracted, the free end of the 2 #pole is thrown toward the ground GND of the electric equipment power supply, and the free end of the 1 #pole is thrown toward the positive pole CVV of the electric equipment power supply; the wire B is connected in series with the relay coil to ground through the current-limiting resistor R20; in this way, the electric equipment will have a stable power input.

In addition, before wire A and wire B enter into the double-pole and double-throw switch K20, the data receiving terminal samples the signal on wire A or wire B. Since the signals on wire A and wire B are inverted, it is sufficient to sample the signals on one wire only, and after sampling the signals, it can be judged whether it is necessary to invert the data strings through a number of protocols, which are very abundant at present, such as In communication, send a series of “010101” signal to do the header, so that the data receiving terminal will detect the frequency of the digital signal from the header of this message, which can later be positioned in a middle of a digital cycle for sampling; in addition, data signals decoded out later can also be detected, for example, if a front FLAG signal is detected as 7FH, indicating that inversion is not required, and if it is 80F, inversion is required, and so on.

In short, in this embodiment, there are many methods of sampling, such as: when the data receiving end samples electric signals, acquiring signals on the wire A or wire B, and comparing the acquired electric signals with ground of the electric equipment power supply; if the voltage of the acquired electric signal is higher than the ground of the power supply, judging that the received digital signal is “1”, otherwise, judging that the received digital signal is “0”; and then, carrying out reverse phase calculation on the received numeric string according to communication protocol to restore the original transmission signal.

In addition, when the data receiving end samples electric signals, signals on the wire A and wire B can be acquired at the same time, and comparing the acquired signals on the wire A with the acquired signals on the wire B, if the voltage of the acquired signal on the wire A is higher than that of the acquired signal on the wire B, the received digital signal is judged to be “1”, and if not, the received digital signal is “0”; and then, carrying out reverse phase calculation on the received numeric string according to communication protocol to restore the original transmission signal.

When the data receiving end samples electric signals, a wire C can also be adopted to connect the wire A and wire B, a current-limiting resistor is connected in series with the wire C, and the current direction of current on the wire is acquired; if the current direction flows from the wire A to the wire B, the received digital signal is judged to be “1”, otherwise, the digital signal is “0”; and then, carrying out reverse phase calculation on the received numeric string according to communication protocol to restore the original transmission signal.

In the embodiment, at the data sending end, the sent digital fundamental wave signal is a unipolar non-return-to-zero code.

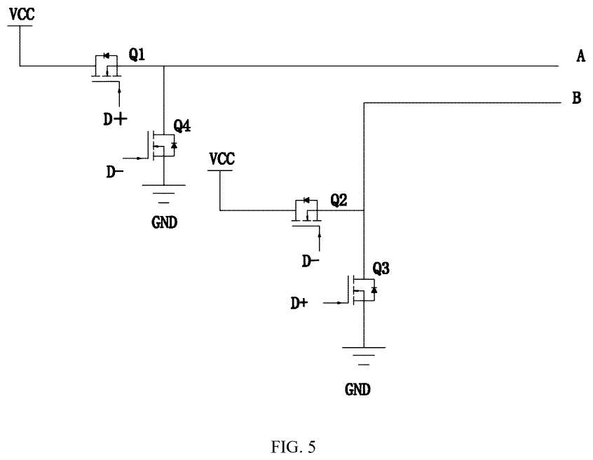

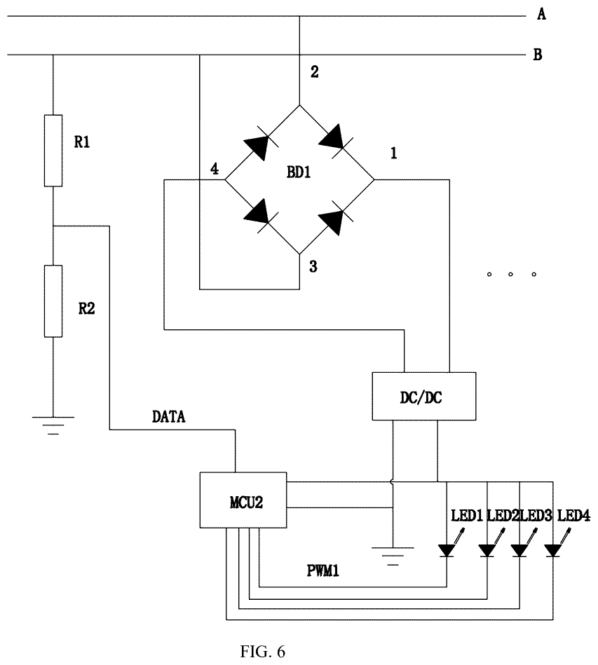

The embodiment is shown as FIG. 5 and FIG. 6, this embodiment is an example of centralized DC power supply to LED lamp while using a power supply control board to send control signals to a lamp board of each LED lamp, also using a pair of wires A and B to simultaneously supply power to and send control signals (digital signals) to the distant LED lamp, and using a different modulation device and power restoration device as compared to Embodiment 1.

In the embodiment, the modulation device is shown in FIG. 5, comprising a MOS switch tube Q1, a MOS switch tube Q2, a MOS switch tube Q3, and a MOS switch tube Q4; the positive pole of the DC power supply is connected to drain electrodes of the MOS switch tube Q1 and the MOS switch tube Q2, respectively, and source electrodes of the MOS switch tube Q1 and the MOS switch tube Q2 are connected to the wire A and the wire B, respectively.

The ground GND of the DC power supply is connected to drain electrodes of MOS switch tube Q3 and MOS switch tube Q4, and source electrodes of MOS switch tube Q3 and MOS switch tube Q4 is connected to wire A and wire B, respectively.

A digital signal D+ output from the data sending terminal is connected to grid electrodes of the MOS switch tube Q1 and the MOS switch tube Q3, respectively; and an inverse phase signal D− of the digital signal D+ is connected to grid electrodes of the MOS switch tube Q2 and the MOS switch tube Q4, respectively.

A waveform as shown in FIG. 2 is also generated utilizing the modulation device of this embodiment. Wire A and wire B are connected to the power supply VCC and the power supply ground GND of the DC power supply through an electronic switch, and the MOS switch tubes Q1 and Q2 and Q4 are not disconnected and closed at the same time, and when the MOS switch tubes Q1 and Q3 are closed, that is, when the signal D+ is a high level, the signal D− is a low level, and the MOS switch tubes Q2 and Q4 are disconnected, and at this time, the signals on the wire A are connected to the power supply VCC, and the signals on the wire B are connected to the power supply ground GND. The signal on wire B is the power supply ground GND. Next to each other, when D+ is low, the MOS switch tubes Q1 and Q3 are disconnected, while the MOS switch tubes Q2 and Q4 are closed.

In this embodiment, waveforms as shown in FIG. 2 are also generated by utilizing the modulation device of this embodiment. The wire A and wire B are connected to the power supply VCC and the power supply ground GND of the DC power supply through an electronic switch, and the MOS switch tubes Q1, Q2 and Q4 are not disconnected and closed at the same time, and when the MOS switch tubes Q1 and Q3 are closed, i.e., when the signal D+ is at a high level, the signal D− is at a low level, the MOS switch tubes Q2 and Q4 are disconnected, and at this time, the signal on the wire A is VCC of the power supply, and the signal on the wire B is ground GND of the power supply; when D+ is at a low lever, the MOS switch tubes Q1 and Q3 are disconnected, while the MOS switch tubes Q2 and Q4 are closed, and at this time, the signal on the wire A is ground GND of the power supply, and the signal on the wire B is VCC of the power supply.

In this embodiment, the power restoration circuit is also very simple and effective, as shown in FIG. 6, a bridge BD is used, and pin 1 of the bridge is connected to wire A. Pin 3 is connected to wire B, and pin 1 is connected to VCC of a power input end of the electric equipment, while pin 4 is connected to GND of the power supply interface, and here, in order to make the LED power supply conform to the input power supply of the LED lamp beads, a DC-DC power supply is also used for the power supply transformation, which is because that voltage output by DC power supply at a control end of output is generally 12-36 DC, while the LED lamp bead voltage is generally 3.5 VDC, therefore, DC-DC conversion is performed for the power supply here; in practice, if the voltage itself matches, the bridge BD can be directly connected to the power supply input interface of the electric equipment.

As shown in FIG. 6, whether wire A or wire B is VCC of the power supply, they are connected to the DC-DC power supply end through a conducted diode in a bridge, while a negative pole of the DC-DC power supply is connected to wire B or wire A through a cconducted diode, i.e., the ground of the power supply. The electrical signal sampling circuit includes a sampling resistor R1 and a sampling resistor R2; said sampling resistor R1 and sampling resistor R2 are connected in series between wire B or wire A and ground, and a sampling signal is led out from a common end connected to the sampling resistor R1 and sampling resistor R2 to connect to MCN; the MCU performs data processing on the sampled signals according to a communication protocol to form a control signal PWM signal for the LED lamp bead.

In this embodiment, there is also a MCU on the lamp board to obtain control signals to control each LED on the lamp beads by sampling signals on the wire B. By sampling the signals on the wire B, the control signals are restored to generate the PWN signal to control brightness of each lamp bead to produce colorful lights.

In this embodiment, there can be many such LED lamp boards on wire A and wire B. Since wire A and wire B are to perform differential positive and negative switches on the power supply on the wire A and wire B and realize transmission of signals, so we call this pair of wires as DMPB bus; in practice, the DMPB bus can carry out effective control on the above N LED lamp boards. In addition to transmission of power supply on the DMPB bus, data communication can also be realized, after experimentation, in this embodiment, transmission speed is up to 700 KPBS at 12V power supply, in line with the commonly used smart home control.

In this embodiment, the working principle of signal sending end of the DMPB control board is described as below:

working process: two level signals, D− and D+, of MCUI are utilized and each control two MOS switch tubes, wherein D− and D+ are opposite levels. In this way, it can realize the signal carrier transmission and ensure the power supply of subsequent light bulb connected. MOS switch tube Q1 and MOS switch tube Q4, MOS switch tube Q2 and MOS switch tube Q3 are switches with opposite levels.

The operating states are as follows:
when logic 1 is sent: D+ is at a high level, D− is at a low level: MOS switch tube Q1 turns on, MOS switch tube Q4 turns off, MOS switch tube Q2 turns off, MOS switch tube Q3 turns on;
When Logic0 is sent: D+ is at a low level, D− is at a high level: MOS switch tube Q1 turns off, MOS switch tube Q4 turns on, MOS switch tube Q2 turns on, MOS switch tube Q3 turns off.

Working Principle of a signal end of DMPB lamp board:

Working process: BD1 is a bridge circuit; the purpose is to get stable power supply from the power line which transmits signal from the DMPB bus. After power conversion, it supplies power to the lamp and MCU2-1. After getting Logic1 and Logic0 messages, MCU2-1 is connected to a IO port of a current chip through a Data line to parse them and get the correct data.

The lamp device utilizes signals transmitted by DMPB to perform automatic numbering function.

The working procedure of the automatic numbering operation is described as follows:

Step 1. start a control board. Start to send numbering information through DMPB, the first lamp position must be connected with a first lamp and fixed as a first numbered lamp.

Step 2. after the first lamp is successfully numbered, then connect a second lamp, the second lamp recognizes DMPB numbering information sent by the control board to identify its own lamp at number 2 position.

Step 3. loop operation of the second step, until all lamps are numbered.

1. A method for transmitting DC power supply and signals by using a pair of wires, wherein the DC power supply adopts a pair of wires to supply power to electric equipment, and a data sending end communicates to a data receiving end unidirectionally at the same time; the data sending end is positioned at the DC power supply, and the data receiving end is positioned at an electric equipment end;
at a power supply end, a pair of wires is divided into a wire A and a wire B, when the digital signal sent by the data sending end is at high level, the wire A is connected with a positive pole of the power supply, the wire B is connected with a ground of the power supply, when the digital signal sent by the data sending end is at low level, the wire A is connected with the ground of the power supply, and the wire B is connected with the positive pole of the power supply;
at the electric equipment end, the data receiving end samples electric signals, regardless of whether it is wire A or wire B, and the wire with high level is connected with a positive pole of the electric equipment power supply, and an other wire is connected with a ground of the electric equipment power supply.

2. The method for transmitting DC power supply and signals by using a pair of wires of claim 1, wherein when the data receiving end samples electric signals, acquiring signals on the wire A or wire B, and comparing the acquired electric signals with ground of the electric equipment power supply; if the voltage of the acquired electric signal is higher than the ground of the power supply, judging that the received digital signal is “1”, otherwise, judging that the received digital signal is “0”; and then, carrying out reverse phase calculation on the received numeric string according to communication protocol to restore the original transmission signal.

3. The method for transmitting DC power supply and signals by using a pair of wires of claim 1, wherein when the data receiving end samples electric signals, acquiring signals on the wire A and wire B simultaneously, and comparing the acquired signals on the wire A with the acquired signals on the wire B, if the voltage of the acquired signal on the wire A is higher than that of the acquired signal on the wire B, the received digital signal is judged to be “1”, and if not, the received digital signal is “0”;
and then, carrying out reverse phase calculation on the received numeric string according to communication protocol to restore the original transmission signal.

4. The method for transmitting DC power supply and signals by using a pair of wires of claim 1, wherein when the data receiving end samples electric signals, a wire C is adopted to connect the wire A and wire B, a current-limiting resistor is connected in series with the wire C, and the current direction of current on the wire is acquired; if the current direction flows from the wire A to the wire B, the received digital signal is judged to be “1”, otherwise, the digital signal is “0”; and then, carrying out reverse phase calculation on the received numeric string according to communication protocol to restore the original transmission signal.

5. The method for transmitting DC power supply and signals by using a pair of wires of claim 1, wherein at the data sending end, the sent digital fundamental wave signal is a unipolar non-return-to-zero code.

6. A system for transmitting DC power supply and signals by using a pair of wires, wherein the DC power supply utilizes a pair of wires including wire A and wire B to supply power to an electric terminal equipment, and wherein the DC power supply end also has a data sending terminal utilizing a pair of wires to send digital fundamental wave signals to a data receiving terminal set at the electric terminal equipment;
at the DC power supply end further comprises a modulation device for modulating the digital fundamental wave signal power supply output signal sent by the data sending terminal; said modulation device has wire A connected to the positive pole of the power supply and wire B connected to the ground of the power supply when the digital fundamental wave signal sent by the data sending terminal is at a high level, and wire A connected to the ground of the power supply and wire B connected to the positive pole of the power supply when the digital signal sent by the data sending terminal is at a low level;
at the electric equipment end further comprises an electrical signal sampling circuit and a power restoration device for restoring signals on wire A and wire B into current output signals; said electrical signal sampling circuit is connected to the data receiving terminal, and said power restoration device realizes that, regardless of whether it is wire A or wire B, a wire with a high level is connected to the positive pole of the electric equipment power supply, and the other wire is connected to the ground of the electric equipment power supply.

7. The system for transmitting DC power supply and signals by using a pair of wires of claim 6, wherein said modulation device includes a double-pole-double-throw switch K10 controlled by a relay, a triode Q10, and a current-limiting resistor R10; a fixed end of a 1 #pole of said double-pole-double-throw switch K10 is connected to the wire A, a fixed end of a 2 #pole is connected to the wire B; when the relay is attracted, a free end of the 1 #pole is thrown to a positive pole (VCC) of the DC power supply, and the 2 #pole is thrown to the ground (GND) of the DC power supply. When the relay is not attracted, the free end of the 1 #pole is thrown to the ground (GND) of the DC power supply, and the free end of the 2 #pole is thrown to the positive pole (VCC) of the DC power supply; the positive pole (VCC) of the power supply is connected to a collector of the triode Q10 through the current-limiting resistor R10, and an emitter of the triode Q10 is connected to the ground of the DC power supply through a relay coil, and a base is connected to the data sending terminal.

8. The system for transmitting DC power supply and signals by using a pair of wires of claim 6, wherein said modulation device comprises a MOS switch tube Q1, a MOS switch tube Q2, a MOS switch tube Q3, and a MOS switch tube Q4;
the positive pole (VCC) of the DC power supply is connected to drain electrodes of the MOS switch tube Q1 and the MOS switch tube Q2, respectively, and source electrodes of the MOS switch tube Q1 and the MOS switch tube Q2 are connected to the wire A and the wire B, respectively;
the ground (GND) of the DC power supply is connected to drain electrodes of MOS switch tube Q3 and MOS switch tube Q4, and source electrodes of MOS switch tube Q3 and MOS switch tube Q4 are connected to wire A and wire B, respectively;
a digital signal D+ output from the data sending terminal is connected to grid electrodes of the MOS switch tube Q1 and the MOS switch tube Q3, respectively; and an inverse phase signal D− of the digital signal D+ is connected to grid electrodes of the MOS switch tube Q2 and the MOS switch tube Q4, respectively.

9. The system for transmitting DC power supply and signals by using a pair of wires of claim 6, wherein said power restoration device comprises a double-pole double-throw switch K20 controlled by a relay, and a current-limiting resistor R20; a fixed end of a 1 #pole of said double-pole double-throw switch K20 is connected to the wire A, and a fixed end of the 2 #pole is connected to the wire B, and when the relay is attracted, a free end of the 2 #pole is thrown to the positive pole (VCC) of the electric equipment power supply, and the 2 #pole is thrown to the ground (GND) of the electric equipment power supply; when the relay is not attracted, the free end of the 2 #pole is thrown toward the ground (GND) of the electric equipment power supply, and the free end of the 1 #pole is thrown toward the positive pole (VCC) of the electric equipment power supply; the wire B is connected in series with the relay coil to ground through the current-limiting resistor R20.

10. The system for transmitting DC power supply and signals by using a pair of wires of claim 9, wherein said electrical signal sampling circuit includes a sampling resistor R1 and a sampling resistor R2; said sampling resistor R1 and sampling resistor R2 are connected in series between wire B or wire A and ground, and a sampling signal is led out from a common end connected to the sampling resistor R1 and sampling resistor R2 to connect to the data receiving terminal.
